(19) United States
(12) Patent Application Publication
(10) Pub. No.: US 2004/0241866 A1
(43) Pub. Date: Dec. 2, 2004

(54) High-throughput purification process

(76) Inventors: Nathan Collins, San Mateo, CA (US); Jeffrey Wheatley, Fairfax, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/869,780

(22) Filed: Jun. 15, 2004

Related U.S. Application Data
(63) Continuation of application No. 09/864,595, filed on May 23, 2001, now abandoned.
(60) Provisional application No. 60/206,424, filed on May 23, 2000.

(51) Int. Cl. G01N 1/10

(52) U.S. Cl. 436/55

(57) ABSTRACT

A component of a chemical mixture is isolated via a high-throughput purification process. An analytical retention time and corresponding analytical chromatographic parameters are determined for the component. Based on the analytical retention time and the corresponding analytical chromatographic parameters, preparative chromatographic parameters are determined to isolate the component at an accelerated retention time using a preparative column. The chemical mixture is eluted through the preparative column using the preparative chromatographic parameters, and the component is isolated at the accelerated retention time.

### CROSS REFERENCE TO RELATED APPLICATIONS

This application claims the benefit of U.S. Provisional Application No. 60/206,424, filed on May 23, 2000.

### TECHNICAL FIELD

The present invention relates to high-throughput purification process useful for isolating one or more components of a chemical mixture.

### BACKGROUND

Chromatography has been used to isolate a component of a chemical mixture comprising a plurality of components. Various advances in chromatography have led to the advancement of this science to afford faster and more efficient methods of separating components of a chemical mixture.

Chromatographic separations, such as, for example, high performance liquid chromatography (HPLC) separations, are very useful in isolating individual components of even a small amount of a chemical mixture. HPLC separations used include, for example, reversed-phase HPLC separations and normal phase HPLC separations. These HPLC separations typically require developing a stationary phase of a HPLC column with a mobile phase (solvent, or a mixture of solvents or liquids, also referred to as an eluent). In particular, gradient elution HPLC separations typically involve varying a composition and/or polarity of the mobile phase, such as by beginning with a relatively high polarity and gradually reducing the polarity of the mobile phase such that a desired component from the chemical mixture elutes through the column. This development of the column is also referred to as developing a gradient.

With the advent of the science of combinatorial chemistry, wherein an array comprising different components are rapidly and simultaneously synthesized in very small amounts, chromatographic separations, particularly “HPLC separations, have become important tools to isolate individual components from the array. However, previously used “HPLC separations can be time consuming and often require a considerable amount of mobile phase. There is thus a need for a method that can be used to isolate a component of a given chemical mixture using a reduced amount of mobile phase while accomplishing the purification/isolation of the component in a fairly rapid manner.

### SUMMARY OF THE INVENTION

One aspect of the invention relates to a method for isolating a component of a chemical mixture, which comprises: (a) identifying an analytical retention time and corresponding analytical chromatographic parameters for the component; (b) based on the analytical retention time and the corresponding analytical chromatographic parameters, determining preparative chromatographic parameters to isolate the component at an accelerated retention time using a preparative column; (c) eluting the chemical mixture through the preparative column using the preparative chromatographic parameters; and (d) isolating the component at the accelerated retention time.

Another aspect of the invention pertains to a gradient elution chromatography method, which comprises: (a) identifying at least one component in a chemical mixture; (b) identifying a first set of gradient elution parameters to elute the component through a first column at a first elution time; (c) using the first set of gradient elution parameters, determining a second set of gradient elution parameters to elute the component through a second column at a second elution time; and (d) eluting the chemical mixture through the second column using the second set of gradient elution parameters.

Yet another aspect of the invention relates to a method to separate a component of a chemical mixture. The method comprises: (a) identifying the component by eluting a first portion of the chemical mixture through a first column using a first set of gradient elution parameters; (b) determining a first retention time for the component associated with the first column and the first set of gradient elution parameters; (c) using the first retention time and the first set of gradient elution parameters, determining a second set of gradient elution parameters to elute the component through a second column at a second retention time; and (d) separating the component by eluting a second portion of the chemical mixture through the second column using the second set of gradient elution parameters.

### DETAILED DESCRIPTION OF THE INVENTION

The present invention is directed to isolating one or more components of a chemical mixture using chromatographic separation. A component to be isolated will be referred to as a desired component. In particular, embodiments of the invention enable a desired component to be isolated at an accelerated rate compared to conventional chromatographic separations. Embodiments of the invention effect elution of the desired component through a column (e.g., a preparative HPLC column) at a given retention time, which retention time may be selected (e.g., pre-selected) by a user. Embodiments of the invention enable the retention time of the desired component to be predicted and/or controlled. The desired component is eluted through the column and may be collected during a time interval such that the retention time for the desired component falls within this time interval. Embodiments of the invention enable selective collection of the desired component during this time interval, while extraneous impurities in the chemical mixture (e.g., components other than the desired component), which elute at retention times outside of this time interval, need not be collected. Thus, in comparison with conventional chromatographic separations in which extraneous impurities are typically collected in addition to the desired component, embodiments of the invention may significantly increase efficiency of a separation procedure and may result in significant cost savings from a simplification of post-separation, downstream processing. In addition to reducing and/or enabling selection of the retention time, embodiments of the present invention can also be cost effective by reducing an amount of mobile phase required to isolate the desired component, as compared to conventional chromatographic separations.

### DEFINITIONS

The following definitions may apply to some of the elements described with regard to some embodiments of the invention. These terms may likewise be expanded upon herein.

The term “analytical chromatographic separation” is intended to mean a chromatographic separation for identifying a component or components (e.g., a desired component) of a chemical mixture. The analytical chromatographic separation may comprise eluting one or more components through an analytical column. The analytical chromatographic separation can be characterized and/or affected by analytical chromatographic parameters.

The term “capacity factor” is used to mean a parameter or factor that indicates a partition of a component between a stationary phase and a mobile phase. The capacity factor may be defined as a mole ratio of the component associated with the stationary phase to that associated with the mobile phase at a given mobile phase composition. In gradient elution separations, the capacity factor of the component is typically lowered during separation to facilitate elution of the component through a column.

The term “chemical mixture” is intended to mean a group of one or more components.

The term “chromatographic parameters” is used to mean parameters or factors that characterize and/or affect a chromatographic separation. Exemplary chromatographic parameters include analytical chromatographic parameters that characterize and/or affect an analytical chromatographic separation, scaled-up chromatographic parameters that characterize and/or affect a scaled-up chromatographic separation, preparative chromatographic parameters that characterize and/or affect a preparative chromatographic separation, and a set of gradient elution parameters that characterize and/or affect a gradient elution separation.

The term “chromatographic separation” is intended to mean any technique involving separating two or more components by dissolving or otherwise dispersing the components in a mobile phase and passing the mobile phase through a stationary phase. Typically, the stationary phase is included in a column. Examples of chromatographic separations comprise liquid chromatography (LC) separation, HPLC separation, gas chromatography (GC) separation, reversed-phase LC separation, liquid-solid chromatography separation, ion-exchange chromatography separation, ion-pair chromatography separation, adsorption chromatography separation, gradient elution separation, gradient elution HPLC separation, and normal or isocratic elution separation.

The term “component” is used to mean a compound or collection of compounds.

The term “dwell time” is intended to mean the amount of time required for a mobile phase to travel between an inlet of a gradient producing device (e.g., a solvent mixer) to an inlet of a column.

The term “gradient elution parameters” is intended to mean parameters or factors that characterize and/or affect a gradient elution separation. Examples of gradient elution parameters comprise initial mobile phase composition, final mobile phase composition, gradient time interval, flow rate of mobile phase injected into a column, type of stationary phase included in the column, size (e.g., length and/or diameter) of the column, ambient temperature, void time, void volume, and gradient steepness parameter. As one of ordinary skill in the art will understand, gradient elution parameters may comprise additional parameters or factors (other than the examples listed above) that may characterize and/or affect a gradient elution separation. Alternatively or in conjunction, gradient elution parameters may comprise a parameter or factor that includes a combination of other parameters or factors and/or a parameter or factor that is determined using other parameters or factors.

The term “gradient elution separation” is intended to mean a chromatographic separation wherein a mobile phase composition is varied for at least a portion of a gradient time interval. Gradient elution separation typically comprises varying a composition of the mobile phase for the gradient time interval and injecting the mobile phase into a column (e.g., a HPLC column) in accordance with a flow rate. For example, the composition of the mobile phase may be varied by varying a polarity of the mobile phase in a linear gradient for the gradient time interval. In a reversed-phase LC separation, the polarity of the mobile phase is decreased for the gradient time interval. In a normal phase LC separation, the polarity of the mobile phase is increased for the gradient time interval. Typically, the polarity of the mobile phase is varied by adjusting relative amounts of two or more solvents of different polarity. For instance, the polarity of the mobile phase may be varied by adjusting relative amounts of a more polar solvent A (e.g., water) and a less polar solvent B (e.g., acetonitrile). The mobile phase may also include one or more solvents with amounts that are not varied during the gradient time interval, such as, for example, a relatively small quantity (e.g., 0.05 volume percent) of trifluoroacetic acid (TFA).

The term “gradient steepness parameter” is used to mean a parameter or factor that characterizes and/or affects a gradient elution separation. The gradient steepness parameter is typically dependent on a combination of factors comprising type of stationary phase included in a column, gradient time interval, change in volume fraction of a less polar solvent of a mobile phase over the gradient time interval, void volume of the column, and flow rate of the mobile phase injected into the column.

The term “gradient time interval” is intended to mean the amount of time during which a mobile phase composition may be varied in a gradient elution separation.

The term “mobile phase composition” is used to mean a parameter or factor that characterizes and/or affects a chromatographic separation. For embodiments of the invention utilizing gradient elution separations, the mobile phase composition is varied for at least a portion of a gradient time interval. The mobile phase composition may comprise a volume fraction of a less polar solvent included in a mobile phase. Alternatively or in conjunction, the mobile phase composition may comprise a volume fraction of a more polar solvent included in the mobile phase and/or a volume fraction of a solvent with an amount that is not varied during the gradient time interval. As one of ordinary skill in the art will understand, a volume fraction may be expressed as a percentage or in some other equivalent form.

The term “preparative chromatographic separation” is intended to mean a chromatographic separation for isolating or separating a component or components (e.g., a desired component) of a chemical mixture. A preparative chromatographic separation can comprise eluting one or more components through a preparative column. A preparative chromatographic separation can be characterized and/or affected by preparative chromatographic parameters.

The term “retention time” is used to mean the amount of time required for a component to elute through a column in a chromatographic separation. As used herein, retention time is used interchangeably with elution time. For embodiments of the invention utilizing gradient elution separations, the retention time may be measured relative to a start of a gradient for a mobile phase at an inlet of a gradient producing device (e.g., a solvent mixer). Alternatively, the retention time may be measured relative to another reference point, such as, for example, the start of the gradient for the mobile phase at an inlet or outlet of the column to account for a dwell time and/or a void time associated with the column.

The term “retention volume” is intended to mean the amount of volume of mobile phase required for a component to elute through a column in a chromatographic separation. The retention volume may be determined using a retention time for the component and a flow rate of mobile phase injected into the column.

The term “scaled-up chromatographic separation” is intended to mean a scaled-up chromatographic separation that comprises eluting one or more components through a preparative column while one or more analytical chromatographic parameters are preserved (e.g., an analytical initial mobile phase composition, an analytical final mobile phase composition, and an analytical gradient steepness parameter). The term is also used to mean a scaled-up chromatographic separation that is characterized and/or affected by scaled-up chromatographic parameters or that is a “hypothetical” chromatographic separation (e.g., a chromatographic separation that is not actually performed).

The term “void time” is intended to mean the amount of time required for an unretained mobile phase to pass through a column. The void time may be determined using a void volume and a flow rate of mobile phase injected into the column. For example, the void time for an analytical column may be represented by V_{A}/F_{A}, where V_{A} is the void volume of the analytical column, and F_{A} is the flow rate of the mobile phase injected into the analytical column.

The term “void volume” is intended to mean the volume of a column through which an unretained mobile phase passes. The void volume may indicate a portion of a column not occupied by a stationary phase. The void volume may be represented as being proportional to a diameter (e.g., inner diameter of the column) and length of the column. For example, the void volume for an analytical column may be represented as being proportional to DA_{A}²L_{A}, where D_{A} is the diameter of the analytical column, and L_{A} is the length of the analytical column.

### LIST OF SYMBOLS AND ABBREVIATIONS

The following list of symbols and abbreviations may apply to some of the elements described with regard to some embodiments of the invention.

A—more polar solvent in mobile phase

B—less polar solvent in mobile phase

b—gradient steepness parameter for analytical chromatographic separation

b₁—gradient steepness parameter for scaled-up chromatographic separation

D_{A}—diameter of analytical column

D_{P}—diameter of preparative column

F_{A}—flow rate of mobile phase injected into analytical column

F_{P}—flow rate of mobile phase injected into preparative column

HPLC—high performance liquid chromatography

k_{A1}—(equal to kₒ₁ for some embodiments of the invention) capacity factor of desired component at scaled-up initial mobile phase composition φ_{A1}

k_{A2}—capacity factor of desired component at preparative initial mobile phase composition

kₒ—capacity factor of desired component at analytical initial mobile phase composition

kₒ₁—capacity factor of desired component at scaled-up initial mobile phase composition

L_{A}—length of analytical column

L_{P}—length of preparative column

S—slope from plot of logarithm of capacity factor versus mobile phase composition

TFA—trifluoroacetic acid

t_{d}—dwell time required for mobile phase to travel between inlet of a gradient producing device to inlet of analytical column

t_{d1}—dwell time required for mobile phase to travel between inlet of a gradient producing device to inlet of preparative column

t_{g}—analytical retention time

t_{g1}—scaled-up retention time

t_{g2}—accelerated retention time

t_{G}—analytical gradient time interval

t_{G1}—scaled-up gradient time interval

t_{G2}—preparative gradient time interval

tₒ—void time of analytical column

tₒ₁—void time of preparative column

V_{A}—void volume of analytical column

V_{P}—void volume of preparative column

φ_{A1}—scaled-up initial mobile phase composition (expressed as initial volume fraction of less polar solvent B)

φ_{A2}—preparative initial mobile phase composition (expressed as initial volume fraction of less polar solvent B)

φ_{B2}—preparative final mobile phase composition (expressed as final volume fraction of less polar solvent B)

Δφ—change in analytical mobile phase composition over t_{G} (expressed as change in volume fraction of less polar solvent B)

Δφ₁—change in scaled-up mobile phase composition over t_{G1} (expressed as change in volume fraction of less polar solvent B)

Δφ₂—change in preparative mobile phase composition over t_{G2} (expressed as change in volume fraction of less polar solvent B)

A general approach according to some embodiments of the present invention is discussed as follows. In a first step, a desired component of a chemical mixture is identified. According to some embodiments of the invention, the desired component is identified using a chromatographic separation, such as, for example, an analytical chromatographic separation. In particular, according to an embodiment of the invention, the desired component is eluted through a first column using a first set of chromatographic parameters. According to another embodiment of the invention, the desired component is identified by eluting a first portion of the chemical mixture through the first column using a first set of gradient elution parameters. The first column is an analytical column, according to some embodiments of the invention. A chromatogram may be obtained, and the desired component may be identified by associating the desired component with a peak (or peaks) in the chromatogram.

In a second step, a first retention time and/or corresponding first set of chromatographic parameters is/are identified for the desired component. According to some embodiments of the invention, the first retention time is identified from a chromatogram (such as from the chromatogram discussed above), which may indicate one or more retention times associated with one or more components of the chemical mixture. According to an embodiment of the invention, the first set of chromatographic parameters comprises a first set of gradient elution parameters associated with elution of the desired component through the first column at the first retention time.

In a third step, a second set of chromatographic parameters is determined based on the first retention time and/or the corresponding first set of chromatographic parameters. According to an embodiment of the invention, the second set of chromatographic parameters enable the desired component to be isolated at an accelerated retention time using a second column. According to another embodiment of the invention, the second set of chromatographic parameters comprises a second set of gradient elution parameters, and the second set of gradient elution parameters enable the desired component to elute through the second column at a second retention time. The second column is a preparative column, according to some embodiments of the invention. The accelerated retention time and/or the second retention time may be selected by a user, according to some embodiments of the invention.

In a fourth step, the desired component is isolated. According to some embodiments of the invention, the desired component is isolated using a chromatographic separation, such as, for example, a preparative chromatographic separation. In particular, according to an embodiment of the invention, the chemical mixture (or a portion thereof) is eluted through the second column using the second set of chromatographic parameters determined in the third step. The desired component may be isolated at the accelerated retention time associated with the second set of chromatographic parameters. According to another embodiment of the invention, the second set of chromatographic parameters comprises the second set of gradient elution parameters determined in the third step, and the chemical mixture (or a portion thereof) is eluted through the second column using the second set of gradient elution parameters. The component may be collected within a time interval that includes the second retention time associated with the second set of gradient elution parameters.

The present invention is further understood with reference to the following detailed description of the steps discussed above.

As discussed previously, the first step comprises identifying a desired component of a chemical mixture. In the present embodiment, this involves performing an analytical chromatographic separation for the chemical mixture to identify the desired component from among other components of the chemical mixture. In particular, a first portion of the chemical mixture is eluted through an analytical HPLC column using analytical chromatographic parameters, and a HPLC chromatogram, such as, for example, in the form of a liquid chromatography-mass spectra (LC-MS), is obtained. As one of ordinary skill in the art will understand, a typical HPLC chromatogram is characterized by one or more peaks associated with one or more components in the chemical mixture, and the desired component is identified by associating the desired component with a peak (or peaks) in the HPLC chromatogram, such as, for example, a largest peak in the HPLC chromatogram. It should be recognized that the desired component may, in general, be associated with any of the peaks in the HPLC chromatogram. It should be further recognized that one or more additional desired components may be identified, such as, for example, by associating the one or more additional components with respective peaks in the HPLC chromatogram.

After identifying the desired component, the second step comprises identifying an analytical retention time and corresponding analytical chromatographic parameters for the desired component. In the present embodiment, the analytical retention time of the desired component is identified from the HPLC chromatogram, which indicates analytical retention times of various components of the chemical mixture. Alternatively, the HPLC chromatogram may indicate analytical retention volumes of the various components of the chemical mixture, and the analytical retention time for the desired component may be determined from a corresponding analytical retention volume for the component. It should be recognized that the second step may be performed for one or more additional desired components of the chemical mixture.

In addition to identifying the analytical retention time, the analytical chromatographic parameters associated with elution of the desired component through the analytical HPLC column is identified. In the present embodiment, the analytical chromatographic parameters comprise a first set of gradient elution parameters associated with gradient elution of the first portion of the chemical mixture through the analytical HPLC column. As one of ordinary skill in the art will understand, gradient elution separation typically comprises varying a composition of a mobile phase for a gradient time interval and injecting the mobile-phase into a column (e.g., the analytical HPLC column) in accordance with a flow rate. In the present embodiment, a polarity of the mobile phase is decreased in a linear gradient for the gradient time interval. In the present embodiment, the polarity of the mobile phase is varied by adjusting relative amounts of two or more solvents of different polarity. In particular, the polarity of the mobile phase may be varied by adjusting relative amounts of a more polar solvent A (e.g., water) and a less polar solvent B (e.g., acetonitrile). The mobile phase may also include one or more solvents with amounts that are not varied during the gradient time interval, such as, for example, a relatively small quantity (e.g., 0.05 volume percent) of TFA.

In the present embodiment, the first set of gradient elution parameters may comprise one or more of the following parameters associated with the analytical chromatographic separation: analytical initial mobile phase composition, analytical final mobile phase composition, analytical gradient time interval, analytical flow rate, type of stationary phase included in the analytical HPLC column, analytical HPLC column size (e.g., length and/or diameter of the analytical HPLC column), ambient temperature associated with the analytical chromatographic separation, void volume of the analytical HPLC column, analytical dwell time, and analytical gradient steepness parameter. In the present embodiment using reversed-phase chromatography separation, the analytical initial mobile phase composition may comprise a volume fraction of 0 for the less polar solvent (i.e., 0% B or 100% A), and the analytical final mobile phase composition may comprise a volume fraction of 1 for the less polar solvent (i.e., 100% B or 0% A). As discussed previously, a small fixed volume fraction of a third solvent (e.g., TFA) may also be present.

The third step comprises determining preparative chromatographic parameters based on the analytical retention time and the corresponding analytical chromatographic parameters. The preparative chromatographic parameters are determined to enable the desired component to be isolated at an accelerated retention time using a preparative HPLC column. In the present embodiment, the preparative chromatographic parameters comprise a second set of gradient elution parameters associated with gradient elution of a second portion (e.g., a remaining portion) of the chemical mixture through the preparative HPLC column. According to the present embodiment, the preparative HPLC column typically has a different size relative to the analytical HPLC column used for the analytical chromatographic separation (e.g., larger diameter and/or length for the preparative HPLC column). The larger diameter and/or length of the preparative HPLC column may enable more efficient isolation of the desired component (e.g., larger amounts of the desired component may be isolated). It should be recognized that the preparative HPLC column may have a larger diameter and a same or smaller length (or a larger length and a same or smaller diameter) relative to the analytical HPLC column, according to some embodiments of the invention. It should be further recognized that the third step may be performed for one or more additional desired components of the chemical mixture.

In the present embodiment, the third step comprises a plurality of steps described as follows. First, a scaled-up retention time of the desired product on the preparative HPLC column is determined based on a scale-up from the analytical HPLC column to the preparative HPLC column. This scale-up accounts for the larger length and/or diameter of the preparative HPLC column and/or any change in linear velocity of mobile phase while directly translating one or more of the analytical chromatographic parameters. In particular, in the present embodiment, the analytical initial mobile phase composition, the analytical final mobile phase composition, and the analytical gradient steepness parameter from the analytical chromatographic separation are preserved or held constant for determining the scaled-up retention time. This scaled-up retention time indicates a retention time associated with elution of the desired component through the preparative HPLC column if one or more of the analytical chromatographic parameters are preserved (e.g., if the analytical initial mobile phase composition, the analytical final mobile phase composition, and the analytical gradient steepness parameter are used for elution through the preparative HPLC column).

As one of ordinary skill in the art will understand, a gradient steepness parameter is dependent on a combination of factors, including type of stationary phase included in a column, gradient time interval, change in volume fraction of a less polar solvent over the gradient time interval, void volume of the column, and flow rate of the mobile phase injected into the column. In the present embodiment, in moving from the analytical HPLC column to the preparative HPLC column, the analytical gradient steepness parameter may be preserved by including a same type of stationary phase in the preparative HPLC column as used in the analytical HPLC column while adjusting one or more of the other factors that affect the gradient steepness parameter to account for the different sizes of the two columns. In an alternate embodiment of the invention, different types of stationary phase may be included in the analytical and preparative HPLC columns, and the other factors that affect the gradient steepness parameter may be adjusted accordingly.

As a function of the relative sizes of the analytical and preparative HPLC columns and/or as a result of the relative flow rates at which the analytical and preparative chromatographic separations are carried out, the scaled-up retention time will typically be longer than the analytical retention time. In other words, it typically takes longer for the desired component to elute through the larger preparative HPLC column if the analytical initial mobile phase composition, the analytical final mobile phase composition, and the analytical gradient steepness parameter are preserved from the analytical chromatographic separation.

Based on the analytical retention time and the corresponding analytical chromatographic parameters, the scaled-up retention time t_{g1} may be determined using the following equation:

t_{g1}=(tₒ₁/tₒ)(t_{g})−(tₒ₁/tₒ)(t_{d)+}t_{d1} (1)

where t_{g} represents the analytical retention time for the desired component, tₒ represents a void time of the analytical HPLC column (which may be expressed as V_{A}/F_{A} with V_{A} representing a void volume of the analytical HPLC column and F_{A} representing a flow rate of mobile phase injected into the analytical HPLC column), tₒ₁ represents a void time of the preparative HPLC column (which may be expressed as V_{P}/F_{P} with V_{P} representing a void volume of the preparative HPLC column and F_{P} representing a flow rate of mobile phase injected into the preparative HPLC column), t_{d} represents a dwell time of the analytical HPLC column, and t_{d1} represents a dwell time of the preparative HPLC column.

Second, a scaled-up gradient time interval for the preparative HPLC column is determined. As with the scaled-up retention time, the scaled-up gradient time interval is determined while preserving one or more of the analytical chromatographic parameters (e.g., the analytical initial mobile phase composition, the analytical final mobile phase composition, and the analytical gradient steepness parameter from the analytical chromatographic separation).

Since the preparative HPLC column may have a larger diameter and/or length and/or lower linear velocity of mobile phase relative to the analytical HPLC column, the scaled-up gradient time interval will typically be longer than the analytical gradient time interval. In other words, a mobile phase typically has to be injected through the larger preparative HPLC column for a longer duration if the analytical initial mobile phase composition, the analytical final mobile phase composition, and the analytical gradient steepness parameter are preserved from the analytical chromatographic separation.

The scaled-up gradient time interval t_{G1} which is obtained from a scale-up from the analytical HPLC column to the preparative HPLC column may be determined using the following equation:

t_{G1}=(tₒ₁/tₒ)t_{G} (2)

where tₒ₁ and tₒ are defined as in equation (1) and t_{G} represents the analytical gradient time interval.

Third, using the scaled-up retention time and the scaled-up gradient time interval values obtained above, preparative chromatographic parameters are determined to effect separation/isolation of the desired component at an accelerated retention time using the preparative HPLC column. In the present embodiment, the preparative chromatographic conditions are determined while preserving the analytical gradient steepness parameter from the analytical chromatographic separation. However, other preparative chromatographic parameters, such as, for example, a preparative initial mobile phase composition, a preparative final mobile phase composition, a preparative gradient time interval, and/or a preparative flow rate, may differ from their analytical counterparts.

In particular, the preparative initial mobile phase composition is determined to effect separation/isolation of the desired component at an accelerated retention time using the preparative “HPLC column. In the present embodiment of the invention, the preparative initial mobile phase composition is determined while preserving the analytical gradient steepness parameter from the analytical chromatographic separation. The accelerated retention time may be fixed or may be variable and selected by a user. Typically, the accelerated retention time will be selected to be shorter than the scaled-up retention time to isolate the desired component at an accelerate rate.

The preparative initial mobile phase composition φ_{A2} may be determined using the following equation:

φ_{A2}=(Δφ)/t_{G1})(t_{g1}−t_{g2})+φ_{A1} (3)

where t_{g1} is defined as in equation (1), t_{G1} is defined as in equation (2), t_{g2} represents the accelerated retention time, Δφ represents a change in analytical mobile phase composition over t_{G} (expressed as change in volume fraction of less polar solvent B), and φ_{A1} represents a scaled-up initial mobile phase composition (expressed as initial volume fraction of less polar solvent B). In the present embodiment, the scaled-up initial mobile phase composition has a same value as the analytical initial mobile phase composition (e.g., volume fraction of 0 for B). As can be understood with reference to equation (3), the accelerated retention time t_{g2} may be shorter than the scaled-up retention time t_{g1} by adjusting the preparative initial mobile phase composition φ_{A2} to comprise a higher volume fraction of the less polar solvent B.

Once the value for the preparative initial mobile phase composition has been determined, the following equation may be used to determine a preparative final mobile phase composition φ_{B2} to effect separation/isolation of the desired component at the accelerated retention time using the preparative HPLC column:

φ_{B2}=φ_{A2}+(Δφ₁)(t_{G2}/t_{G1}) (4)

where t_{G1} is defined as in equation (2), φ_{A2} is defined as in equation (3), Δφ₁ represents a change in scaled-up mobile phase composition over t_{G1} (expressed as change in volume fraction of less polar solvent B), and t_{G2} represents a preparative gradient time interval to effect separation/isolation of the desired component at the accelerated retention time using the preparative HPLC column. In the present embodiment, Δφ₁ is equal to Δφ as defined in equation (3) (e.g., 1).

Typically, a preparative gradient time interval that is equal to or slightly larger (e.g., 5% larger) than the accelerated retention time is adequate to effect separation/isolation of the desired component. Hence, the preparative gradient time interval t_{G2} in equation (4) may be selected to be equal to the accelerated retention time (or some other value around the accelerated retention time). Alternatively or in conjunction, the preparative final mobile phase composition φ_{B2} may be selected to comprise a volume fraction of 1 for the less polar solvent (e.g., 100% B), and the preparative gradient time interval t_{G2} may be determined using equation (4). As one of ordinary skill in the art will understand, other appropriate values for the preparative final mobile phase composition may be selected and inserted into equation (4) to determine the preparative gradient time interval.

Once the preparative chromatographic parameters have been determined from the third step, the fourth step comprises isolating the desired component. In the present embodiment, this involves performing a preparative chromatographic separation for the chemical mixture to isolate the desired component from among other components of the chemical mixture. In particular, a second portion (e.g., a remaining portion) of the chemical mixture is eluted through the preparative HPLC column using the preparative chromatographic parameters. The desired component may be isolated at the accelerated retention time. More particularly, the desired component may be collected within a time interval (e.g., an Accelerated Retention Window) that includes the accelerated retention time.

It should be recognized that one or more additional desired components of the chemical mixture may be isolated. In particular, each additional desired component may be isolated, for example, by eluting a respective portion of the chemical mixture through the preparative HPLC column and isolating the additional desired component at a respective accelerated retention time. Alternatively, multiple desired components may be isolated from a single injection of the chemical mixture. For example, each additional desired component may be eluted through the preparative HPLC column and isolated at a respective accelerated retention time, if the additional desired component elutes subsequent to the desired component selected for determining the preparative initial mobile phase composition and if the preparative gradient time interval is determined to encompass the accelerated retention time of the additional desired component.

The following examples describe specific aspects of the invention to illustrate the invention and provide a description of the present method for those of ordinary skill in the art. The examples should not be construed as limiting the invention, as the examples merely provide specific methodology useful in understanding and practicing the invention.

### EXAMPLES

### Relevant Equations

A. Derivation of Equation (1) for the Scaled-Up Retention Time t_{g1}

The analytical retention time t_{g} for the desired component on the analytical column (e.g., a reversed-phase HPLC column) under gradient elution conditions, using a linear solvent strength gradient, is given by:

t_{g}=(tₒ/b) log(2.3kₒb+1)+tₒ+t_{d} (A1)

or alternatively,

(t_{g}−tₒ−t_{d})/tₒ=(1/b) log(2.3kₒb+1). (A2)

The scaled-up retention time t_{g1} for the desired component on the preparative column (e.g., a reversed-phase HPLC column) under gradient elution conditions, using a linear solvent strength gradient, is given by:

t_{g1}=(tₒ₁/b₁) log(2.3kₒ₁b₁+1)+tₒ₁+t_{d1} (A3)

or alternatively,

(t_{g1}−tₒ₁−t_{d1})/tₒ₁=(1/b₁) log(2.3kₒ₁b₁₊1). (A4)

Since b=b₁ and kₒ=kₒ₁ according to an embodiment of the invention,

(t_{g}−tₒ−t_{d})/tₒ=(t_{g1}−tₒ₁−t_{d1})/tₒ₁, (A5)

and the scaled-up retention time on the preparative column t_{g1} may be calculated from that on the analytical column as:

t_{g1}=(tₒ₁/tₒ)(t_{g)-(}tₒ₁/tₒ)(t_{d})+t_{d1}. (A6)

B. Derivation of equation (2) for the scaled-up gradient time interval t_{G1}

For elution of the desired component on the analytical column (e.g., reversed-phase HPLC column) under gradient elution conditions, using a linear solvent strength gradient, the gradient steepness parameter b is given by:

b=SΔφV_{A}/t_{G}F_{A} (B1)

where V_{A} represents the void volume of the analytical column, F_{A} represents the flow rate of the mobile phase injected into the analytical column, t_{G} represents the analytical gradient time interval, and Δφ represents the change in the volume fraction of the strong solvent (e.g., a less polar solvent) over t_{G}. S is the slope from a plot of log k vs. φ,

log k=log kₒ−Sφ (B2)

where k is the capacity factor associated with the desired component at a particular volume fraction of the strong solvent φ, and kₒ is the capacity factor at the initial volume fraction of the strong solvent (i.e., at initial solvent strength). Since the stationary phases, solvent systems, and Δφ are identical for the analytical and scaled-up chromatographic separations according to an embodiment of the invention, corresponding values for kₒ and S will be the same for the scaled-up chromatographic separation.

For a translation and preservation of the gradient steepness from the analytical to the scaled-up chromatographic separation, the gradient steepness parameters from the analytical and scaled-up chromatographic separations are identical (i.e., b=b₁). From equation (B1) and the analogous equation for the scaled-up chromatographic separation, it follows that V_{A}/t_{G}F_{A} is equal to V_{P}/t_{G1}F_{P}, given identical values for S and Δφ.

Since tₒ=V_{A}/F_{A} and tₒ₁=V_{P}/F_{P} for the analytical and scaled-up chromatographic separations, respectively, one obtains:

tₒt_{G}=tₒ₁/t_{G1} (B3)

and the scaled-up gradient time interval t_{G1} may be calculated as:

t_{G1}=(tₒ₁/tₒ) t_{G}. (B4)

C. Derivation of equation (3) for the preparative initial mobile phase composition φ_{A2} and equation (4) for the preparative gradient time interval t_{G2}

After a value for the scaled-up retention time t_{g1} has been determined, the preparative initial mobile phase composition φ_{A2} is determined or adjusted such that the desired component will elute at the accelerated retention time t_{g2} on the preparative column. φ_{A2} is derived in the following way.

If t_{g1} represents the scaled-up retention time and conditions are selected such that the gradient steepness parameter b from the analytical chromatographic separation is preserved, then:

$${t}_{g1} - {t}_{g2} = ( {t}_{o1} / b ) log ( 2.3 {k}_{A1} b ) - ( {t}_{o1} / b ) log ( 2.3 {k}_{A2} b ) \\ = ( {t}_{o1} / b ) log ( {k}_{A1} / {k}_{A2} ) \qquad ( C1 )$$

where a standard approximation for the logarithm terms was made, k_{A1} is the capacity factor of the desired component at the initial volume fraction of the strong solvent φ_{A1} for the scaled-up chromatographic separation, and k_{A2} is the capacity factor of the desired component at the initial volume fraction of the strong solvent φ_{A2} for the preparative chromatographic separation (to elute the desired component at the accelerated retention time t_{g2}).

From a plot of a logarithm of the capacity factor against volume fraction of the strong solvent, one obtains:

log(k_{A1})=log kₒ−S(φ_{A1}) (C2)

log(k_{A2})=log kₒ−S(φ_{A2}) (C3)

and

log(k_{A1}/k_{A2})=S(φ_{A2}−φ_{A1}) (C4).

Combining equations (C1) and (C4), one obtains:

t_{g1}−t_{g2}=(tₒ₁/b)S(φ_{A2}−φ_{A1}). (C5)

After substituting for b, one obtains:

t_{g1}−t_{g2}=(t_{G1}/Δφ₁)(φ_{A2}−φ_{A1}) (C6)

where Δφ₁ (which is equal to Δφ) is, the change in the volume fraction of the strong solvent (e.g., a less polar solvent) over t_{G1} for the scaled-up chromatographic separation. The preparative initial mobile phase composition φ_{A2} that will result in elution at t_{g2} is thus given by:

φ_{A2}=(Δφ₁/t_{G1})(t_{g1}−t_{g2})+φ_{A1}. (C7)

For b to remain constant,

Δφ₂/t_{G2}=Δφ₁/t_{G1} (C8)

where Δφ₂=φ_{B2}−φ_{A2} and φ_{B2}is the final preparative mobile phase coomposition. Accordingly, the preparative gradient time interval t_{G2} may be calculated from:

t_{G2}=(Δφ₂/Δφ₁)t_{G1.} (C9)

### Example 1

Samples (each comprising a respective desired component) from Qualification Library BAB 106 QL 2 were examined. An Excel spreadsheet program was constructed from appropriate mathematical expressions to facilitate computations. Injections were made on an analytical column, and the resulting analytical retention times along with corresponding analytical chromatographic parameters were identified and entered into the Excel spreadsheet program. The Excel spreadsheet program was then used to calculate: (1) scaled-up retention times which would be obtained from injections on a preparative column from a direct translation of the conditions used for the analytical column (e.g., preserving the analytical initial and final mobile phase compositions and analytical gradient steepness parameter); and (2) preparative chromatographic parameters such that all desired components would elute through the preparative column at some selected accelerated retention time. Injections were then made on the preparative column using the preparative chromatographic parameters calculated in (2), and the “actual” accelerated retention times were measured and compared to the selected accelerated retention time.

Analytical chromatographic separations were performed on a Prodigy ODS(3) column, 4.6×100 mm, and preparative chromatographic separations were performed on a Prodigy ODS(3) column, 21.2×100 mm. The stationary phases (i.e., packings) in the two columns were of the same product (C18, 5 μm) and from the same manufacturer's lot.

A total of 54 crude samples, each containing a reference standard drawn from BAB 106, were subjected to the above procedures using analytical chromatographic parameters of 0-100% acetonitrile, including 0.05% TFA, over 9 minutes at a flow rate of 2.0 mL per minute. The major peak from each separation was targeted as the desired component. All preparative chromatographic separations were carried out at 10 mL per minute. Based on measured values of void time tₒ for the analytical column and void time tₒ₁ for the preparative column, a scale-up (direct translation) of the conditions used in the analytical chromatographic separation would correspond to a scaled-up gradient time interval of 0-100% acetonitrile over 40.3 minutes (t_{G1}) at 10 mL per minute.

The range of analytical retention times obtained from the above measurements was 4.99-9.05 minutes. Calculations using equation (1) for a scale-up from analytical to preparative column dimensions showed that this would correspond to scaled-up retention times in a range of 18.0-36.6 minutes on the preparative column had the initial mobile phase composition not been adjusted from 0% acetonitrile to φ_{A2}.

Values for φ_{A2} were calculated to effect elution of all samples at a selected accelerated retention time t_{g2} of 10 minutes, selected to represent estimated initial capacity factor values of about 10. Using these conditions, the “actual” accelerated retention times that were obtained from injections into the preparative column ranged over 9.51-10.71 minutes.

The results show that large reductions in retention time (and mobile phase consumption) may be achieved by an embodiment of the present invention. By adjusting the preparative initial mobile phase composition, all components were eluted at less than 11 minutes. Without this adjustment, a scale-up from the analytical column to the preparative column would have required up to about 37 minutes to elute the most strongly retained component. Flow rates in this study were limited to 10 mL per minute. By performing the preparative chromatographic separations at 25 mL per minute using the same gradient steepness parameter employed in these measurements, the 40.3 minute gradient time interval would be reduced to about 16 minutes, and the 10 minute accelerated retention time target would correspond to 4 minutes. A proportionate decline in the values for the “actual” accelerated retention times would give a range of 3.80-4.29 minutes. Further reductions could be achieved by reducing the length of the preparative column. All other factors being equal, a flow rate of 25 mL per minute on a 50 mm preparative column would reduce “actual” accelerated retention times to values on the order of 2 minutes.

### Example 2

Two chromatographic separations were performed on a Prodigy ODS(3) column, 21.2×100 mm. A first portion of a sample was eluted using conventional (e.g., scaled-up) chromatographic parameters of 0-100% acetonitrile, including 0.05% TFA, over 15.29 minutes at a flow rate of 25 mL per minute, and a HPLC chromatogram was obtained for the first portion. The major peak from the HPLC chromatogram was targeted as the desired component.

Next, a second portion of the sample was eluted through the same column using preparative chromatographic parameters of 60.3-86.4% acetonitrile, containing 0.05% TFA, over 4.0 minutes at a flow rate of 25 mL per minute, and a HPLC chromatogram was obtained for the second portion. The preparative chromatographic parameters were determined to elute the desired component through the column at a selected accelerated retention time of 4 minutes.

Elution of the desired component through the column was observed to be substantially faster using the preparative chromatographic parameters (i.e., “actual” accelerated retention time of 3.95 minutes versus conventional retention time of 13.20 minutes).

### Example 3

An Excel spreadsheet program was constructed from appropriate mathematical expressions to facilitate computations. Analytical chromatographic parameters and analytical retention times for various samples (each comprising a respective desired component) of Library BAB007:16 were identified and entered into the Excel spreadsheet program. A preparative gradient time interval t_{G2} of 4 minutes and an accelerated retention time t_{g2} of 4 minutes were selected and also entered into the Excel spreadsheet program.

The Excel spreadsheet program was used to determine scaled-up retention times t_{g1} and preparative chromatographic parameters for elution of the various components at t_{g2}. In particular, the Excel spreadsheet program was used to determine scaled-up gradient time intervals t_{G1}, preparative initial mobile phase compositions (φ_{A2}, and preparative final mobile phase compositions φ_{B2}. Tables 1 and 2 illustrate sample worksheets used to determine the various parameters.

TABLE 1

| tₒ | t_{d} | tₒ₁ | t_{d1} | φ_{A1} | Δφ | t_{G1} | t_{g2} | t_{G2} |
|---|---|---|---|---|---|---|---|---|
| 0.24 | 1.05 | 0.96 | 0.47 | 0 | 1.00 | 15.29 | 4.00 | 4.00 |

TABLE 2

| | | | | | | | |
|---|---|---|---|---|---|---|---|
| Library: BAB007:16 | | | | | | | |
| Packing: Prodigy ODS (3) special; dp: 5 μ; | F_{A} | F_{P} | D_{A} | D_{P} | L_{A} | L_{P} | t_{G} |
| 100A | | | | | | | |
| Analytical Column: 4.6 × 50 mm | 2.35 | 25 | 0.46 | 2.12 | 5 | 10 | 3.83 |
| (SN 284877) | | | | | | | |
| Preparative Column: 21.2 × 100 mm | | | | | | | |
| (SN 284876) | | | | | | | |
| Mixer: 1.5 mL | | | t_{G1} | | | | |
| Solvent system: acetonitrile-water | | | | | | | |
| (0.05% TFA) | | | | | | | |
| | | | 15.29 | | | | |
| Analytical Conditions: 0-100% B, 3.83 min, | | | | | | | |
| 2.35 ml/min | | | | | | | |
| Preparative Conditions: 25.0 ml/min | | | | | | | |
| Scaled-up: t_{G1} = ((t_{G}) (F_{A}) (d_{P})² (L_{P}))/ | | | | | | | |
| ((F_{P}) (d_{A})² (L_{A})) | | | | | | | |
| t_{G1} = [(3.83) (2.35) (2.12)² (10)]/[(25) (.460)² (5)] | | | | | | | |
| t_{G1} = 15.29 min | | | | | | | |

Table 3 illustrates a sample worksheet used to determine scaled-up retention times t_{g1}, preparative initial mobile phase compositions φ_{A2}, and preparative final mobile phase compositions (φ_{B2} for the various samples (each comprising a respective desired component). As can be seen in Table 3, each desired component is associated with a corresponding analytical retention time t_{g}. The preparative chromatographic parameters were determined such that all desired components would elute at a selected accelerated retention time of 4 minutes.

TABLE 3

| | φ_{A2} = (t_{g1} − t_{g2}) * (Δφ/t_{G1}) + φ_{A1} | | | | | φ_{B2} = | |
|---|---|---|---|---|---|---|---|
| | | | | 100 * | 100 * | (t_{G2}/t_{G1}) + φ_{A2} | |
| Sample | t_{g} | t_{g1} | φ_{A2} | φ_{A2} | φ_{A2N} | φ_{B2} | 100 * φ_{B2} |
| A1 | 4.36 | 13.71 | 0.63 | 63.49 | 72.12 | 0.90 | 89.64 |
| A4 | 4.69 | 15.03 | 0.72 | 72.12 | 61.66 | 0.98 | 98.28 |
| A5 | 4.29 | 13.43 | 0.62 | 61.66 | 72.64 | 0.88 | 87.81 |
| A6 | 4.71 | 15.11 | 0.73 | 72.64 | 73.17 | 0.99 | 98.80 |
| A7 | 4.73 | 15.19 | 0.73 | 73.17 | 63.49 | 0.99 | 99.32 |
| A8 | 4.36 | 13.71 | 0.63 | 63.49 | 61.40 | 0.90 | 89.64 |
| B2 | 4.28 | 13.39 | 0.61 | 61.40 | 66.37 | 0.88 | 87.55 |
| B3 | 4.47 | 14.15 | 0.66 | 66.37 | 71.34 | 0.93 | 92.52 |
| B4 | 4.66 | 14.91 | 0.71 | 71.34 | 54.34 | 0.97 | 97.49 |
| B5 | 4.01 | 12.31 | 0.54 | 54.34 | 58.78 | 0.80 | 80.49 |
| B6 | 4.18 | 12.99 | 0.59 | 58.78 | 60.35 | 0.85 | 84.94 |
| B7 | 4.24 | 13.23 | 0.60 | 60.35 | 63.23 | 0.87 | 86.51 |
| B9 | 4.35 | 13.67 | 0.63 | 63.23 | 24.78 | 0.89 | 89.38 |
| B10 | 2.88 | 7.79 | 0.25 | 24.78 | 71.60 | 0.51 | 50.94 |
| C2 | 4.67 | 14.95 | 0.72 | 71.60 | 69.77 | 0.98 | 97.75 |
| C4 | 4.6 | 14.67 | 0.70 | 69.77 | 73.69 | 0.96 | 95.92 |
| D1 | 4.75 | 15.27 | 0.74 | 73.69 | 82.06 | 1.00 | 99.85 |

The preparative chromatographic parameters were entered into a Gilson Unipoint 215 HPLC Operations List to direct preparative chromatographic separations of the various samples. In particular, the various samples were eluted in a sequence, with φ_{A2N} representing a next preparative initial mobile phase composition to elute a next sample of the sequence. Table 4 illustrates the Operations List.

TABLE 4

| | | | | INJECT | | | | |
|---|---|---|---|---|---|---|---|---|
| | Description | Control Method | SAMPLE TUBE | VOLUME | FRAC_SITE | φ_{A2} | φ_{B2} | φ_{A2N} |
| 1 | BAB | C:\JEFF\47032P01.GCT | SAMPLES: 1 | 1600 | FRACTIONS: 1 | 63.49 | 89.64 | 72.12 |
| | 007:16A1 | | | | | | | |
| 2 | A4 | C:\JEFF\47032P01.GCT | SAMPLES: 4 | 1600 | FRACTIONS: 1 | 72.12 | 98.28 | 61.66 |
| 3 | A5 | C:\JEFF\47032P01.GCT | SAMPLES: 5 | 1600 | FRACTIONS: 1 | 61.66 | 87.81 | 72.64 |
| 4 | A6 | C:\JEFF\47032P01.GCT | SAMPLES: 6 | 1600 | FRACTIONS: 1 | 72.64 | 98.80 | 73.17 |
| 5 | A7 | C:\JEFF\47032P01.GCT | SAMPLES: 7 | 1600 | FRACTIONS: 1 | 73.17 | 99.32 | 63.49 |
| 6 | A8 | C:\JEFF\47032P01.GCT | SAMPLES: 8 | 1600 | FRACTIONS: 1 | 63.49 | 89.64 | 61.40 |
| 7 | B2 | C:\JEFF\47032P01.GCT | SAMPLES: 13 | 1600 | FRACTIONS: 1 | 61.40 | 87.55 | 66.37 |
| 8 | B3 | C:\JEFF\47032P01.GCT | SAMPLES: 14 | 1600 | FRACTIONS: 1 | 66.37 | 92.52 | 71.34 |
| 9 | B4 | C:\JEFF\47032P01.GCT | SAMPLES: 15 | 1600 | FRACTIONS: 1 | 71.34 | 97.49 | 54.34 |
| 10 | B5 | C:\JEFF\47032P01.GCT | SAMPLES: 16 | 1600 | FRACTIONS: 1 | 54.34 | 80.49 | 58.78 |
| 11 | B6 | C:\JEFF\47032P01.GCT | SAMPLES: 17 | 1600 | FRACTIONS: 1 | 58.78 | 84.94 | 60.35 |
| 12 | B7 | C:\JEFF\47032P01.GCT | SAMPLES: 18 | 1600 | FRACTIONS: 1 | 60.35 | 86.51 | 63.23 |
| 13 | B9 | C:\JEFF\47032P01.GCT | SAMPLES: 20 | 1600 | FRACTIONS: 1 | 63.23 | 89.38 | 24.78 |
| 14 | B10 | C:\JEFF\47032P01.GCT | SAMPLES: 21 | 1600 | FRACTIONS: 1 | 24.78 | 50.94 | 71.60 |
| 15 | C2 | C:\JEFF\47032P01.GCT | SAMPLES: 24 | 1600 | FRACTIONS: 1 | 71.60 | 97.75 | 69.77 |
| 16 | C4 | C:\JEFF\47032P01.GCT | SAMPLES: 26 | 1600 | FRACTIONS: 1 | 69.77 | 95.92 | 73.69 |
| 17 | C5 | C:\JEFF\47032P01.GCT | SAMPLES: 27 | 1600 | FRACTIONS: 1 | 73.69 | 99.85 | 82.06 |

Analytical chromatographic separations were performed using a Prodigy ODS (5 μm) 4.6×50 mm column at a flow rate of 2.35 mL/minute and a gradient of 0-100% B over 3.83 minute. Preparative chromatographic separations were performed using a Prodigy ODS (5 μm) 21.2×100 mm column at a flow rate of 25.0 mL/minute and a gradient time interval of 4 minutes (and using calculated preparative initial and final mobile phase compositions). As discussed previously, the accelerated retention time was selected to be 4 minutes.

Table 5 illustrates a Gilson Unipoint 215 Control Method associated with execution of steps in the Operations List. The Control Method comprises commands to direct preparative chromatographic separations of the various samples.

TABLE 5

| | Time | Device(s) | Command |
|---|---|---|---|
| 1 | 0 | Fraction Collector | Set Collection Valve Divert |
| 2 | 0.01 | Pump A/Pump B | 25(ml/min): 100% Pump A, Ψ_{A2}% Pump B |
| 3 | 0.02 | partial loop fill for 215 as | <start> SAMPLE_TUBE, INJECT_VOLUME |
| | | FC prep | |
| 4 | 0.06 | Detector 17 | Turn Lamp On/Off On |
| 5 | 0.07 | Detector 17 | Set Mode Dual |
| 6 | 0.08 | Detector 17 | Set Dual Sensitivity 1 50 |
| 7 | 0.09 | Detector 17 | Set Dual Sensitivity 2 50 |
| 8 | 0.1 | Detector 17 | Autozero Channels |
| 9 | 0.5 | System Controller | Synchronize |
| 10 | 0.51 | Pump A/Pump B | 25(ml/min): 100% Pump A, Ψ_{A2}% Pump B |
| 11 | 0.52 | Data Channels | Start Chromatogram Channels |
| 12 | 1.09 | Fraction Collector | Collect Positive Peaks Yes |
| 13 | 1.11 | Fraction Collector | Set Fraction by Volume Inside a Peak 8 |
| 14 | 1.12 | Fraction Collector | Set Collection and Travel Depths 53, 53 |
| 15 | 1.38 | Fraction Collector | Set Fraction Site FRAC_Site |
| 16 | 1.46 | Fraction Collector | Set Peak Level 10 |
| 17 | 1.48 | Fraction Collector | Set Peak Width and Peak Sensitivity .15, 3 |
| 18 | 2.40 | System Controller | Synchronize |
| 19 | 3.75 | Fraction Collector | Start Collection |
| 20 | 4.51 | Pump A/Pump B | 25(ml/min): 100% Pump A, Ψ_{A2}% Pump B |
| 21 | 5.01 | Pump A/Pump B | 25(ml/min): 0% Pump A, 100% Pump B |
| 22 | 5.25 | Fraction Collector | Stop Collection |
| 23 | 8.01 | Pump A/Pump B | 25(ml/min): 0% Pump A, 100% Pump B |
| 24 | 8.50 | Pump A/Pump B | 25(ml/min): 100% Pump A, Ψ_{A2N}% Pump B |
| 25 | 13.50 | Pump A/Pump B | 25(ml/min): 100% Pump A, Ψ_{A2N}% Pump B |
| 26 | 13.51 | Data Channels | Stop Chromatogram Channels |

### Example 4

An Excel spreadsheet program was constructed from appropriate mathematical expressions to facilitate computations. Analytical chromatographic parameters and analytical retention times for various samples (each comprising a respective desired component) of Library JES 501QL P5, P6, P7, P8 were identified and entered into the Excel spreadsheet program. An accelerated retention time t_{g2} was selected to be 2.60 minutes and also entered into the Excel spreadsheet program. In the present example, the preparative gradient time interval t_{G2} was defined as 3.00 minutes.

The Excel spreadsheet program was used to determine scaled-up retention times t_{g1} and preparative chromatographic parameters for elution of the various components at t_{g2}. In particular, the Excel spreadsheet program was used to determine preparative initial mobile phase compositions φ_{A2} and preparative final mobile phase compositions φ_{B2}.

Tables 6 and 7 illustrate sample worksheets used to determine the various parameters.

TABLE 6

| tₒ | t_{d} | tₒ₁ | t_{d1} | φ_{A1} | Δφ | t_{G1} | t_{g2} | t_{G2} |
|---|---|---|---|---|---|---|---|---|
| 0.0985 | 0.57 | 0.421 | 0.43 | 0 | 1.00 | 8.55 | 2.60 | 3.00 |

TABLE 7

| | | | | | | | |
|---|---|---|---|---|---|---|---|
| Packing: ZORBAX SB C18 | | | | | | | |
| special; dp: 5 μ; 80A | | | | | | | |
| | F_{A} | F_{P} | D_{A} | D_{P} | L_{A} | L_{P} | t_{G} |
| Analytical Column: 4.6 × 50 mm | 4.7 | 25 | 0.46 | 2.12 | 5 | 5 | 2 |
| (FA 1055) | | | | | | | |
| Preparative Column: 21.2 × 100 | | | | | | | |
| mm (BC 1038) | | | | | | | |

| | | |
|---|---|---|
| Mixer: 1.5 mL | From column | From measured |
| Solvent system: acetonitrile-water | dimensions | quantities |
| (0.05% TFA) | t_{G1} | t_{G1} |
| | 7.9863 | 8.55 |

Solvent Consumption (mL)

| | | |
|---|---|---|
| | Per | |
| | Sample | Total |
| Water | 157 | 11452 |
| Acetonitrile | 107 | 7802 |
| TFA | | 9.6 |

| | |
|---|---|
| Analytical operation | 47120A02.001.GOP |
| (crude analysis): | |
| Analytical operation (purified | 47128A02.001.GOP |
| analysis): | |
| Preparative operation file (ARW | 47128P01.002.GOP |
| purification): | |
| Preparative control file | 47128P01.001.GCT |
| Cycle Time | 10.68 |
| Inj/Flush Time | 2.19 |
| Analytical Conditions: | 0-100% B, 2.00 min, 4.7 ml/min |

Table 8 illustrates a sample worksheet used to determine scaled-up retention times t_{g1}, preparative initial mobile phase compositions φ_{A2}, and preparative final mobile phase compositions φ_{B2} for the various samples (each comprising a respective desired component). As can be seen in Table 8, each desired component is associated with a corresponding analytical retention time t_{g}. The preparative chromatographic parameters were determined such that all desired components would elute at the selected accelerated retention time t_{g2}.

TABLE 8

| | | | | | | φ_{B2} = | |
|---|---|---|---|---|---|---|---|
| φ_{A2} = (t_{g1} − t_{g2}) * (Δφ/(t_{G1}) + φ_{A1} | | | | | | (t_{G2}/t_{G1}) + φ_{A2} | |
| | t_{g} | t_{g1} | φ_{A2} | 100 * φ_{A2} | 100 * φ_{A2N} | φ_{B2} | 100 * φ_{B2} |
| | 1.32 | 3.64 | 0.121 | 12.11 | 13.61 | 0.472 | 47.21 |
| | 1.35 | 3.76 | 0.136 | 13.61 | 15.61 | 0.487 | 48.71 |
| | 1.39 | 3.93 | 0.156 | 15.61 | 22.11 | 0.507 | 50.71 |
| | 1.52 | 4.49 | 0.221 | 22.11 | 16.61 | 0.572 | 57.21 |
| | 1.41 | 4.02 | 0.166 | 16.61 | 14.61 | 0.517 | 51.71 |
| | 1.37 | 3.85 | 0.146 | 14.61 | 17.11 | 0.497 | 49.71 |
| | 1.42 | 4.06 | 0.171 | 17.11 | 23.61 | 0.522 | 52.21 |
| | 1.55 | 4.62 | 0.236 | 23.61 | 17.61 | 0.587 | 58.71 |
| | 1.43 | 4.11 | 0.176 | 17.61 | 22.61 | 0.527 | 52.71 |
| | 1.53 | 4.53 | 0.226 | 22.61 | 26.11 | 0.577 | 57.71 |
| | 1.6 | 4.83 | 0.261 | 26.11 | 28.61 | 0.612 | 61.21 |
| | 1.65 | 5.05 | 0.286 | 28.61 | 35.61 | 0.637 | 63.71 |
| | 1.79 | 5.64 | 0.356 | 35.61 | 29.11 | 0.707 | 70.71 |
| | 1.66 | 5.09 | 0.291 | 29.11 | 16.61 | 0.642 | 64.21 |
| | 1.41 | 4.02 | 0.166 | 16.61 | 18.61 | 0.517 | 51.71 |
| | 1.45 | 4.19 | 0.186 | 18.61 | 20.61 | 0.537 | 53.71 |
| | 1.49 | 4.36 | 0.206 | 20.61 | 21.11 | 0.557 | 55.71 |
| | 1.5 | 4.40 | 0.211 | 21.11 | 13.61 | 0.562 | 56.21 |
| | 1.35 | 3.76 | 0.136 | 13.61 | 12.11 | 0.487 | 48.71 |
| | 1.32 | 3.64 | 0.121 | 12.11 | 11.11 | 0.472 | 47.21 |
| | 1.3 | 3.55 | 0.111 | 11.11 | 14.61 | 0.462 | 46.21 |
| | 1.37 | 3.85 | 0.146 | 14.61 | 16.61 | 0.497 | 49.71 |
| | 1.41 | 4.02 | 0.166 | 16.61 | 15.61 | 0.517 | 51.71 |

The preparative chromatographic parameters were entered into a Gilson Unipoint 215 HPLC Operations List similar to that shown in Example 3 to direct preparative chromatographic separations of the various samples. In particular, the various samples were eluted in a sequence, with φ_{A2N} representing a next preparative initial mobile phase composition to elute a next sample of the sequence.

### Example 5

Four different samples (10:G08; 10:E07; 10:E04; and 10:H08), each comprising a respective desired component, were eluted through a Prodigy ODS column, 21.2×100 mm. All four samples were eluted using water-acetonitrile-TFA mobile phase including 0.05% TFA at a flow rate of 25 mL per minute over 4 minutes and a gradient of 6.53% B per minute. However, each sample was eluted with respective preparative initial mobile phase composition and preparative final mobile phase composition to elute the respective desired component at a selected accelerated retention time of 4 minutes: 37.3-63.5% B for the 10:H08 sample; 74.3-100% B for the 10:G08 sample (6.43% B per minute); 51.7-77.9% B for the 10:E07 sample; and 64.8-91.0% B for the 10:E04 sample.

“Actual” accelerated retention times of the desired components through the column were observed to fall within a range. In particular, the “actual” accelerated retention times varied from 3.50 minutes to 3.95 minutes.

### Example 6

Analytical retention times of desired components associated with 249 samples were determined, ranging from 2.77 to 4.75 minutes. The various samples, each comprising a respective desired component, were then eluted through a column. All samples were eluted using water-acetonitrile mobile phase including 0.05% TFA at a same flow rate and a same gradient time interval. However, each sample was eluted with respective preparative initial mobile phase composition and preparative final mobile phase composition to elute the respective desired component at a selected accelerated retention time of 4.00 minutes. HPLC chromatograms were obtained for the various samples, and “actual” accelerated retention times of the desired components were identified. “Actual” accelerated retention times of the desired components through the column were observed to fall within a range that includes the selected accelerated retention time. In the present example, “actual” accelerated retention times were found to vary from 3.42 minutes to 4.18 minutes. All desired components may be selectively collected within a time interval that comprises this range. An average “actual” accelerated retention time for the 249 samples examined was 3.88 minutes with a standard deviation of 0.14 minutes. An Accelerated Retention Window may be defined as comprising a multiple of the standard deviation taken around the average “actual” accelerated retention time. The probability that a desired component will elute within and/or be collected during the Accelerated Retention Window will depend on the multiple selected. It should be recognized that the multiple may, in general, comprise any real number (e.g., 1, 2, or 2.5). Elution of the desired components using preparative chromatographic parameters occurred significantly faster than elution would have occurred using a direct translation or scaled-up chromatographic parameters, according to calculated t_{g1} values (e.g., up to about 10 minutes faster for a desired component associated with an analytical retention time of 4.50 minutes).

At this point, an ordinary artisan will appreciate the advantages and implications of the present invention. Embodiments of the present invention facilitate one or more of the following: (1) reduction of dead volume that precede and/or follow a peak of interest when conventional chromatographic separations are used; (2) fast elution of a desired component without appreciable loss of resolution; (3) elution of a desired component within a narrow predictable time interval that includes an accelerated retention time; (4) reduced consumption and disposal of solvents associated with an injected mobile phase; (5) selective, confident collection of a desired component that would eliminate necessity to further confirm identity of the desired component, hence simplifying downstream processing; (6) automation of at least a portion of a purification process; (7) by allowing elution time for a component to be estimated within certain confidence limits, an instrument may be programmed to terminate a gradient at an upper boundary of the confidence limit; and (8) reduction of time interval over which fractions must be collected during a purification process—fewer peaks are collected, fewer tubes are required, and sample capacity for a collection platform of fixed dimension is maximized.

An ordinary artisan should require no additional explanation in developing the methods and systems described herein but may nevertheless find some helpful guidance in the preparation of these methods and systems by examining standard reference works in the relevant art. For example, an ordinary artisan may choose to review L. R. Snyder, “Gradient Elution”, from High Performance Liquid Chromatography, Cs. Horvath (ed.), Academic Press, 1980, pp. 207-316 and M. A. Stadalius, H. S. Gold and L. R. Snyder, J Chromatography, 296 (1984), 31-59, the disclosures of which are hereby incorporated by reference in their entirety.

Each of the patent applications, patents, publications, and other published documents mentioned or referred to in this specification is herein incorporated by reference in its entirety, to the same extent as if each individual patent application, patent, publication, and other published document was specifically and individually indicated to be incorporated by reference.

While the present invention has been described with reference to the specific embodiments thereof, it should be understood by those skilled in the art that various changes may be made and equivalents may be substituted without departing from the true spirit and scope of the invention.

For instance, some embodiments of the invention may comprise optimizing or improving other aspects of a chromatographic separation as an alternative or in conjunction with accelerating a rate at which a desired component elutes through a column. For example, preparative chromatographic parameters may be determined to obtain a particular resolution and/or bandwidth for the desired component (in conjunction with or as an alternative to eluting the desired component at an accelerated retention time).

Some embodiments of the invention may comprise first optimizing or improving certain aspects of an analytical chromatographic separation (e.g., by selecting an appropriate value for the analytical gradient steepness parameter) prior to optimizing and or improving separation of a desired component using a preparative chromatographic separation.

Some embodiments of the invention may comprise identifying a desired component in a chemical mixture using an identification method (e.g., a conventional identification method) other than an analytical chromatographic separation. Analytical retention time and analytical chromatographic parameters for the desired component may be available (e.g., from a published source or from a previous analytical chromatographic separation) and would be consulted to determine preparative chromatographic parameters.

Some embodiments of the invention may comprise determining preparative chromatographic parameters to isolate a plurality of desired components of a chemical mixture via a single elution of the chemical mixture (or a portion thereof). According to an embodiment of the invention, the preparative chromatographic parameters are determined such that the desired components of the chemical mixture elute through a column at respective accelerated retention times. Moreover, the plurality of components may be collected within respective time intervals that include the respective accelerated retention times.

Some embodiments of the invention may employ a nonlinear solvent strength gradient (e.g., a piecewise linear solvent strength gradient, a concave gradient shape, or a convex gradient shape) for either or both analytical and preparative chromatographic separations.

As a further example, some embodiments of the invention may comprise optimizing or improving separation of a desired component, wherein a first and a second chromatographic separations are performed using a single column, and wherein a corresponding first and a corresponding second set of chromatographic parameters may differ.

As a final example, some embodiments of the invention may relate to a computer storage product with a computer-readable medium having computer code thereon for performing various computer-implemented operations, such as, for example, to determine preparative chromatographic parameters or to direct elution through a preparative column. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools. It should be recognized that the invention may be (at least partially) embodied in hardwired circuitry in place of, or in combination with, machine-executable software instructions.

The foregoing descriptions of specific embodiments of the present invention are presented for purposes of illustration and description. They are not intended to be exhaustive or to limit the invention to the precise forms disclosed. Various modifications and variations are possible in view of the above teachings. In addition, many modifications may be made to adapt a particular situation, material, composition of matter, process, process step or steps, to the objective, spirit and scope of the present invention. All such modifications are intended to be within the scope of the claims appended hereto.

1-21 (cancelled)

22 A method for isolating a component of a chemical mixture, comprising:
(a) identifying an analytical retention time and corresponding analytical chromatographic parameters for eluting the component through an analytical column;
(b) based on the analytical retention time and the corresponding analytical chromatographic parameters, determining preparative chromatographic parameters to isolate the component at a pre-selected accelerated retention time using a preparative column that is different from the analytical column, wherein determining the preparative chromatographic parameters comprises:
(i) based on the analytical retention time and the corresponding analytical chromatographic parameters, determining a scaled-up retention time and a scaled-up gradient time interval for eluting the component through the preparative column; and
(ii) based on the scaled-up retention time and the scaled-up gradient time interval, determining the preparative chromatographic parameters;
(c) eluting the chemical mixture through the preparative column using the preparative chromatographic parameters; and
(d) isolating the component at the pre-selected accelerated retention time.

23 The method of claim 22, wherein the analytical column and the preparative column have different sizes.

24 The method of claim 22, wherein the pre-selected accelerated retention time is associated with a reduced retention volume for the component.

25 The method of claim 22, further comprising eluting the component through the analytical column using the analytical chromatographic parameters.

26 The method of claim 22, wherein eluting the chemical mixture comprises:
(iii) varying a composition associated with a mobile phase for a gradient time interval; and
(iv) injecting the mobile phase into the preparative column.

27 The method of claim 26, wherein varying the composition associated with the mobile phase comprises varying a polarity of the mobile phase in a linear gradient for the gradient time interval.

28 The method of claim 27, wherein the analytical chromatographic parameters include a gradient steepness parameter, and wherein determining the preparative chromatographic parameters comprises determining the preparative chromatographic parameters while holding the gradient steepness parameter constant.

29 The method of claim 26, wherein determining the preparative chromatographic parameters comprises determining an initial composition associated with the mobile phase.

30 The method of claim 26, wherein determining the preparative chromatographic parameters comprises determining a final composition associated with the mobile phase.

31 The method of claim 26, wherein determining the preparative chromatographic parameters comprises determining the gradient time interval.

32 A gradient elution chromatography method, comprising:
(a) identifying a component in a chemical mixture;
(b) identifying a first set of gradient elution parameters to elute the component through a first column at a first elution time;
(c) selecting a second elution time;
(d) using the first set of gradient elution parameters, determining a second set of gradient elution parameters to elute the component through a second column at the second elution time, wherein the first column and the second column have different sizes; and
(e) eluting the chemical mixture through the second column using the second set of gradient elution parameters.

33 The gradient elution chromatography method of claim 32, wherein the first column and the second column have different diameters.

34 The gradient elution chromatography method of claim 32, wherein the first column and the second column have different lengths.

35 The gradient elution chromatography method of claim 32, wherein determining the second set of gradient elution parameters comprises:
(i) using the first set of gradient elution parameters, determining a third set of gradient elution parameters to elute the component through the second column at a scaled-up elution time; and
(ii) using the third set of gradient elution parameters, determining the second set of gradient elution parameters.

36 The gradient elution chromatography method of claim 32, further comprising collecting the component within a time interval that includes the second elution time.

37 The gradient elution chromatography method of claim 32, wherein the first set of gradient elution parameters and the second set of gradient elution parameters include the same gradient steepness parameter.

38 The gradient elution chromatography method of claim 32, wherein determining the second set of gradient elution parameters comprises adjusting an initial composition of a mobile phase to elute the component through the second column at the second elution time.

39 The gradient elution chromatography method of claim 32, wherein determining the second set of gradient elution parameters comprises adjusting a gradient time interval during which a mobile phase composition is varied to elute the component through the second column at the second elution time.

40 The gradient elution chromatography method of claim 32, wherein identifying the component comprises eluting a first portion of the chemical mixture through the first column using the first set of gradient elution parameters, and eluting the chemical mixture through the second column comprises eluting a second portion of the chemical mixture through the second column using the second set of gradient elution parameters.

41 A method to separate a component of a chemical mixture, comprising:
(a) identifying the component by eluting a first portion of the chemical mixture through a first column using a first set of gradient elution parameters;
(b) identifying a first retention time for the component associated with the first column and the first set of gradient elution parameters;
(c) selecting a second retention time;
(d) using the first retention time and the first set of gradient elution parameters, determining a second set of gradient elution parameters to elute the component through a second column at the second retention time, wherein the first column and the second column have different sizes; and
(e) separating the component by eluting a second portion of the chemical mixture through the second column using the second set of gradient elution parameters.

42 The method of claim 41, wherein a diameter of the second column is greater than a diameter of the first column.

43 The method of claim 41, wherein a length of the second column is greater than a length of the first column.

44 The method of claim 41, wherein determining the second set of gradient elution parameters comprises:
(i) using the first retention time and the first set of gradient elution parameters, determining a third set of gradient elution parameters to elute the component through the second column at a scaled-up retention time; and
(ii) using the scaled-up retention time and the third set of gradient elution parameters, determining the second set of gradient elution parameters.

45 The method of claim 41, wherein the first column is an analytical column, and wherein the second column is a preparative column.

46 The method of claim 41, wherein the first column and the second column comprise the same stationary phase.

47 The method of claim 41, wherein determining the second set of gradient elution parameters comprises determining an initial polarity associated with a mobile phase that is injected into the second column.

48 The method of claim 41, wherein the first set of gradient elution parameters and the second set of gradient elution parameters are characterized by the same gradient steepness parameter.
